(19) United States
(12) Patent Application Publication
(10) Pub. No.: US 2026/0134263 A1
(43) Pub. Date: May 14, 2026

(54) ENHANCED MODEL ARCHITECTURE WITH A LARGE LANGUAGE MODEL (LLM) FOR AUTOMATIC SCRIPT EXECUTION

(71) Applicant: Unisys Corporation, Blue Bell, PA (US)

(72) Inventors: Salvatore SINNO, Leeds (GB); Manigandan Mohan, Blue Bell, PA (US)

(21) Appl. No.: 18/944,393

(22) Filed: Nov. 12, 2024

(51) Int. Cl. G06N 3/0475; G06N 3/045

(52) U.S. Cl. CPC G06N 3/0475; G06N 3/045

(57) ABSTRACT

Executable prompts for computers can be generated from a natural language input. An aspect uses two machine learning models. A first model trained using a diverse dataset is used to generate an initial script from a natural language prompt. The initial script is then provided to a second machine learning model that is trained on system specific scripts. The second machine learning model modifies the initial script to generate the executable script. In some cases, executable scripts may be further modified to conform to a specific data serialization format usable by the end computing system. The data serialization format may be determined from language provided in the prompt to the first machine learning model. The executable script is then provided to the end computing system that performs the computer-executable action in response.

### BACKGROUND

A large language model (LLM) is an artificial intelligence (AI) system designed to understand and generate human-like text based on vast amounts of data. Utilizing deep learning techniques, LLMs are trained on diverse textual data sources, enabling them to predict and produce coherent, contextually relevant sentences. These models can comprehend and generate text across various domains, making them versatile tools for numerous applications. They are used in natural language processing tasks such as text generation, translation, summarization, question answering, and conversational agents. By analyzing and synthesizing human language, LLMs facilitate improved human-computer interaction, streamline content creation, enhance information retrieval, and support complex decision-making processes in various industries.

LLMs use two primary systems to obtain external data: vector databases and feature stores. Vector databases help find relevant documents using similarity searches, functioning either independently or as part of the LLM application. Feature stores are systems or platforms designed to manage and store structured data features used in machine learning and AI applications. These stores provide organized and accessible data, facilitating the training and inference processes in machine learning models like LLMs.

### SUMMARY

At a high level, aspects herein relate to generating executable scripts from natural language using machine learning models. The executable scripts can be executed by an end computing system to perform a computer-executable action.

An aspect uses two machine learning models. A first model trained using a diverse dataset is used to generate an initial script from a natural language prompt. The initial script is then provided to a second machine learning model that is trained on system-specific scripts. The second machine learning model modifies the initial script to generate the executable script. In some cases, executable scripts may be further modified to conform to a specific data serialization format usable by the end computing system. The data serialization format may be determined from language provided in the prompt to the first machine learning model. The executable script is then provided to the end computing system that performs the computer-executable action in response. This technology may be used to allow users to execute computer commands using a natural language input.

This summary is intended to introduce a selection of concepts in a simplified form that is further described in the detailed description section of this disclosure. The summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates a prior art system for generating a machine learning output from a prompt, as described herein;

FIG. 2 illustrates an example machine learning model architecture for generating executable scripts, in accordance with an aspect described herein;

FIG. 3 illustrates example functional entities for components of the machine learning model architecture of FIG. 2, in accordance with an aspect described herein;

FIG. 4 illustrates a table having example operator encodings that may be used when training a machine learning model to generate executable scripts, in accordance with an aspect described herein;

FIG. 5 illustrates an example method of script execution, in accordance with an aspect described herein;

FIG. 6A illustrates an example initial script as generated by a first machine learning model, in accordance with an aspect described herein;

FIG. 6B illustrates an example executable script as generated by a second machine learning model, in accordance with an aspect described herein; and

FIG. 7 illustrates an example computer device in which aspects of the technology may be employed.

### DETAILED DESCRIPTION

A general LLM, like many commercially available LLMs, is an advanced AI system designed to understand and generate human-like text by leveraging deep learning techniques on extensive datasets. These LLMs are usually trained on a diverse set of text sources, enabling them to perform multiple types of tasks, including computer code generation.

One significant problem with traditional, general LLMs is limited knowledge access and manipulation. Since updating an LLM's training dataset frequently is impractical, these models struggle to keep their world knowledge current and to manipulate knowledge precisely. This limitation hampers their performance on knowledge-intensive tasks, making them less effective than task-specific architectures, particularly in domains requiring specialized knowledge.

Additionally, LLMs often lack transparency, making it difficult to understand how they arrive at specific conclusions or answers, thereby earning the reputation of being "black boxes." Another issue is hallucinations in answers, where LLMs generate responses that seem accurate or coherent but are, in reality, fabricated or incorrect.

Augmented LLM models, such as those described herein, help mitigate these issues by incorporating external data sources, improving the accuracy and reliability of the generated content, and providing a more transparent decision-making process. This enhancement is crucial for boosting the overall trustworthiness and effectiveness of LLMs in various applications. Moreover, as will be described, augmented model architectures can improve LLM outputs within a specific domain, such as code generation, to make them more suitable for their final use case. This is particularly beneficial when executing computer code output by LLMs.

Accordingly, the present disclosure provides for a machine learning architecture that generates executable scripts from natural language input prompts. The final output executable scripts have less errors and are more likely to cause a computer to take the intended computer-executable action.

In an example aspect, a natural language prompt is received. The natural language prompt includes a request for a computer-executable action. This may be an action to retrieve data and derive an output, to create content, to create a job request, or any number of actions that may be performed by a computer. The request is received and provided as a prompt to a first machine learning model.

The first machine learning model can be a large language model (LLM). These models, particularly when trained on a diverse dataset having different data domains, are good at interpreting natural language inputs. Having been trained on different data domains, the first machine learning model may take an input request and generate an initial script. The initial script includes computer-usable instructions that may cause a processor to take an action corresponding to the requested action in the natural language prompt.

However, in some cases, the initial prompt may request an action that is performed by a specific system, or otherwise requires more specificity than that first machine learning model generates. For instance, there may be specific end computing systems usable to perform the action, specific file or system addresses, specific libraries, and so forth.

As such, a second machine learning model may be used to modify the output initial script of the first machine learning model. The second model may be trained to generate system specific scripts. Thus, the second machine learning model generates an executable script by modifying the initial script. This is advantageous, because the first machine learning model provides enhanced natural language understanding, while the second machine learning model provides an enhanced ability to customize scripts for specific systems or tasks based on their respective trainings.

The executable script may be further formatted to provide an executable script in a specific data serialization format usable by the end computing system. The end computing system may be identified from the initial prompt, such as whether the prompt specifies an end computer system or specifies a requested action for which the end computing system is configured to perform. Thus, based on the end computing system, the executable script may be modified, in whole or in part, so that it is in a data serialization format usable by the system, such as a JSON (JavaScript Object Notation), XML (extensible markup language), API (application programming interface) call, or the like. The executable script can be provided to the end computing system that performs the computer-executable action defined by the computer instructions of the script.

It will be realized that the methods previously described are only examples that can be practiced from the description that follows, and the examples are provided to more easily understand the technology and recognize its benefits. Additional examples are now described with reference to the figures.

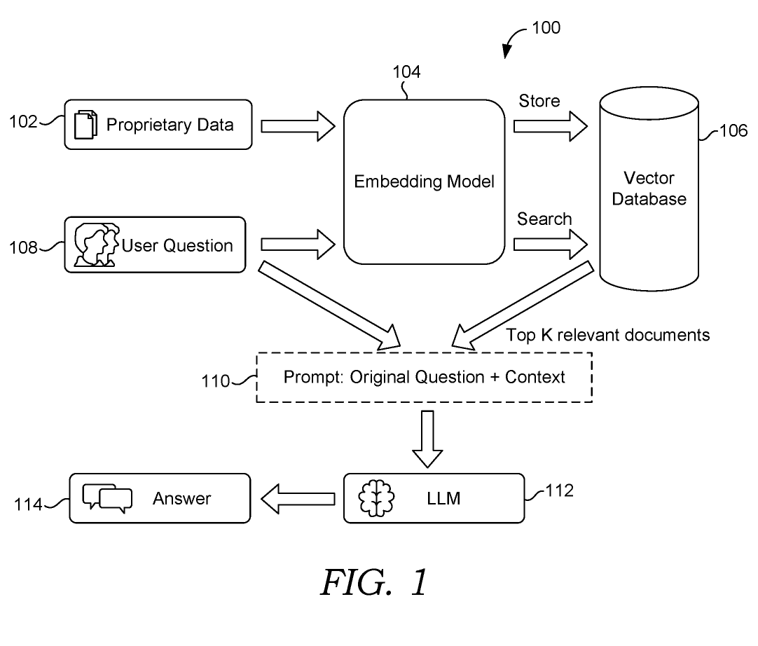

FIG. 1 illustrates a prior art architecture 100 for generating a response from an input. This system attempts to generate usable outputs based on its use of proprietary data. That is, the system attempts to generate a better output by providing more specific input prompt data. This type of system uses a form of prompt engineering where it retrieves data it might not be exposed to during training in order to generate an answer based on the input data.

As illustrated, data 102, which can include proprietary data or data that is otherwise not available during training, is provided to embedding model 104. Embedding model 104 generates an embedded representation of the data, such as a vector representing a data element of data 102 within a vector space that allows for comparison and identification of data elements. The embeddings are then stored in database 106.

When using the system, a user provides input 108. This may be a request for data or other derived information. Input 108 is fed to embedding model 104 and represented as an input embedding, such as an input vector. The input vector is then compared to the data vectors stored in embedding model 104, and data vectors are identified based on their relative distance to the input vector. Proprietary data corresponding to the identified data vectors is retrieved.

The initial input 108 received from the user can be combined with the data retrieved from database 106 to form prompt 110, which may be in the form of one or more prompts. Additional prompt engineering may be employed to generate prompt 110 that is provided as an input to LLM 112. LLM 112 may be an LLM trained on a diverse dataset and thus configured to generate an output in response to prompt 110. In doing so, LLM 112 may contextualize the retrieved data and use it when generating output 114. In this way, LLM 112 is attempting to provide a more specified or customized response using more relevant data that it might not otherwise have been exposed to.

While systems such as architecture 100 provide more relevant outputs than LLMs that do not have access to the additional contextual data, these systems are still limited by the diverse training of the LLM, such as LLM 112. That is, the system is still driven to output responses based on its training and may deviate from, add to, or misunderstand the additional data when generating its output, often forcing it to attempt to fill in any information missing from the contextual information. In essence, it still seeks to understand additional data based on its training, sometimes leading it to draw incorrect inferences.

The present technology departs from this system using one or more machine learning models that have a more focused training. This model can work in coordination with LLMs, such as LLM 112, to generate better outputs, particularly in the area of executable scripts, which often require more specific information, such as an organization's libraries, file locations, and the like, or more specific end computing system information, such as the data serialization format usable by the end system. As will be described, a second machine learning model may itself been an LLM, such as another LLM that has a training distinct from the training of LLM 112. For instance, the second machine learning model may be trained using more specific information corresponding to an entity, e.g., specific libraries, file locations, and the like. The

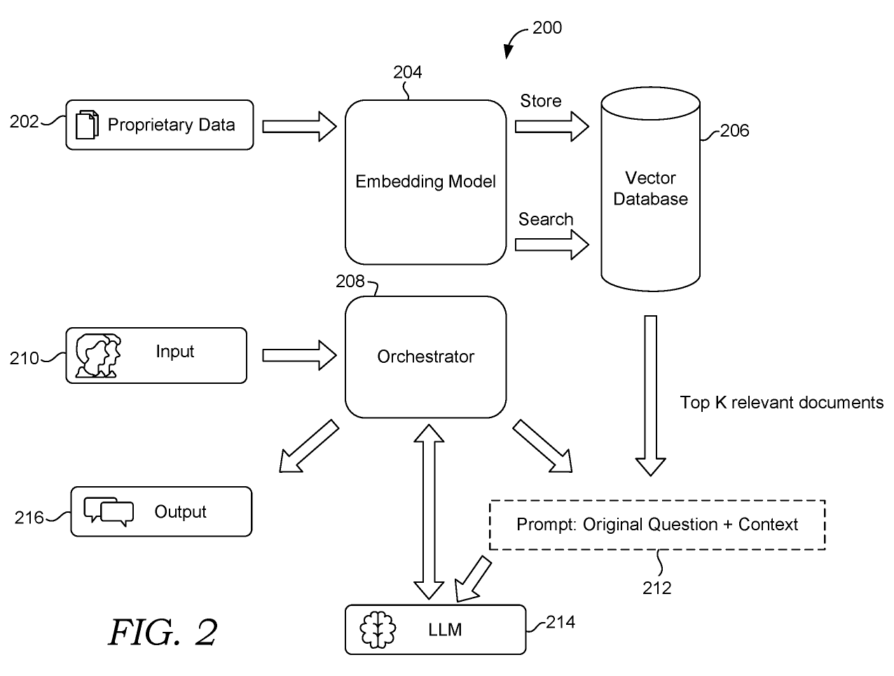

An example architecture 200 that provides an advanced executable script output is illustrated in FIG. 2. In general, architecture 200 may be used to generate an executable script from a natural language input. This allows users to execute computer actions, such as data retrieval, data derivation, content generation, and so forth, using natural language inputs. That is, architecture 200 may generate an executable script that causes a computer-executable action at an end computing system to take action in accordance with the request within the natural language input. The additional use of the second machine learning model, as will be described, now allows users to use natural language inputs with specific computing systems or specific requirements, like specified libraries, addresses, and so forth.

In general, a “script” refers to a set of computer-executable instructions or commands, such as computer code, that is readable by a computing device. In some cases, a scripting engine may be used to convert the script to machine code usable by the computer. Scripts can be in various forms. Some common script notations include Java and Python. Other script types may include SQL and PHP. Scripts may include ansible scripts and executables within cloud-based orchestration services, such as AWS Elastic Beanstalk. These are just examples and not intended to limit the scope of the technology. In contrast, "natural language" refers to text or communication that is in the form of a human language (such as English, Spanish, Chinese, etc.) and is understandable to humans, as opposed to computer code or programming languages. This distinguishes the text from artificial languages like computer programming languages (e.g., Python, Java, etc.) or markup languages (e.g., HTML, XML).

In the example illustrated by FIG. 2, data 202 may be stored for use by other components. In aspects, data 202 is specific data on which one or more of the models have not trained. This may be entity-specific data that corresponds to an entity using architecture 200. For instance, data 202 may be proprietary data, as illustrated.

Data 202 can be provided to embedding model 204 to generate an embedded representation of data 202, such as a vector. In general, the term “vector” and “embedded representation” or “embedding” are used interchangeably, and in the most general sense, they are intended to describe a way of representing data, typically in numerical form, that allows for data comparison. Some examples that may be suitable for use as embedding model 204 include Word2Vec or GloVe that can be used for text data. For image data, CNNs (convolutional neural networks), such as ResNet, may be used. Some models may embed data 202 in a manner that captures contextual or semantic relationships, such as models like BERT (Bidirectional Encoder Representations from Transformers). Embedding model 204 may act independently or as part of another model, such as an LLM, including the first or second machine learning models. These are just some examples, and others models may be used and developed. Embeddings generated by embedding model 204 may be stored in database 206 for identification and data retrieval.

A user may provide input 210. Input 210 may be a natural language for and include a request for a computer-executable action. In general, a computer-executable action is any action capable of being performed by a computer. Some non-limiting examples include: data recall: retrieving stored information from a database or memory; data manipulation: transforming, filtering, or aggregating data to generate new insights or results; content generation: creating new text, images, audio, or other media based on given inputs or parameters; computation: performing mathematical calculations or algorithms to solve problems or otherwise derive information from data; data storage: saving data to a database, file system, or other storage medium for future use; data transmission: sending data over a network to another device; process control: managing and coordinating processes or workflows within a system; decision-making: implementing logic to make decisions based on conditions or rules; data analysis: applying techniques to interpret and gain insights from data; and monitoring: observing and reporting on the status or performance of systems or processes.

In aspects, architecture 200 uses at least two machine learnings models to interpret input 210 and ultimately generate output 216 responsive to it. Output 216 can include a computer-executable script that is usable by an end computing system to perform the computer-executable action described in the input 210.

In the example architecture 200 illustrated, orchestrator 208 interfaces with LLM 214 to generate output 216 from input 210. Here, LLM 214 comprises at least a first machine learning model, while orchestrator 208 comprises at least a second machine learning model. In general, it should be understood that each may comprise more than one model, and various models may be employed and used in coordination with one another. Some examples will be described with regard to orchestrator 208. Thus, it is intended that a “first machine learning model” may include one or more models configured to execute the described functionality, while “second machine learning model” may include any one or more models configured to execute its respective described functionality. While shown as separate entities, other architectures may have different arrangements. The architectures illustrated are intended to provide examples, and other arrangements and architectures performing the described functions are intended to be included within the scope of the disclosure.

Continuing with an example using FIG. 2, input 210 can be combined by orchestrator 208 with data retrieved from database 206. The data may be retrieved using input 210 as the basis of a query to query database 206 and may retrieve contextually or semantically relevant search results. The data may be used by models of architecture 200 when generating output 216 to provide additional context beyond that which the models may infer from training. Orchestrator 208 may employ additional prompt engineering so that prompt 212 directs LLM 214 to provide the outcome corresponding to the request within input 210. For instance, orchestrator 208 may generate prompt 212 to include a request for a script having computer-executable instructions that cause the computer to execute a computer-executable action described by the request.

In another example, orchestrator 208 generates prompt 212 with a request to have the output script provided in a particular computer language. This may be based on an express indication provided within input 210. The particular computer language may be inferred based on a particular end computing system identified to execute the action requested within input 210. In FIG. 2, orchestrator 208 facilitates generation of prompt 212, which is provided to LLM 214 as the first machine learning model, as will be described. In another aspect, input 210 may be provided directly to LLM 214. As noted, this is just one example, and other architectures and processes may be employed.

Prompt 212 may be provided to LLM 214 to generate an initial script describing the computer-executable action in terms of computer instructions. The initial script may be received by orchestrator 208. Prompt 212 may comprise a natural language input from input 210, which is understood and contextualized by LLM 214. In doing so, the initial script may be generated to include a computer-executable action corresponding to the request within input 210.

In aspects, LLM 214 can be a generative model, such as a generative pre-trained transformer, trained on a diverse dataset of different data domains. For example, training data may include natural language text, images, and also computer language. LLM 214 employs natural language processing and deep learning to contextualize an input prompt 212 and generate a responsive output, such as an initial script in response to a prompt requesting a script for a computer-executable action. LLM 214 provides an advantage when using natural language inputs because the diverse training helps LLM 214 better contextualize the input and generate a wide array of various possible outputs.

However, to generate an executable script that can be executed by a particular end computing system, some additional modification may be made to generate a better, more specific script with less likelihood of error. As such, orchestrator 208 can employ a second machine learning model that modifies the initial script generated by the first machine learning model of LLM 214. The initial script may be modified by the second machine learning model of orchestrator 208 to conform to any requirements of the end computing system. The end computing system may be specifically identified in the input 210. In another aspect, the end computing system is identified based on the end computing system being configured to perform the computer-executable action described or inferred from input 210.

Upon generating the executable script, orchestrator 208 may provide the executable script as an output, such as output 216. While illustrated as “question” and “answer," it will be understood that these are not necessarily limited to questions and answers in the grammatical sense, but are more generally illustrative of responses generated in response to information received as an input. In some aspects, the output executable script causes the end computing system to perform the requested computer-executable action. That is, the executable script may be provided or otherwise communicated to the end computing system that interprets the computer instructions of the script and performs an action accordingly. The end computing system may be a local or remote computing system, and may include one or more computing devices in any arrangement, performing one or more actions of the computer-executable action described by the computer instructions of the executable script.

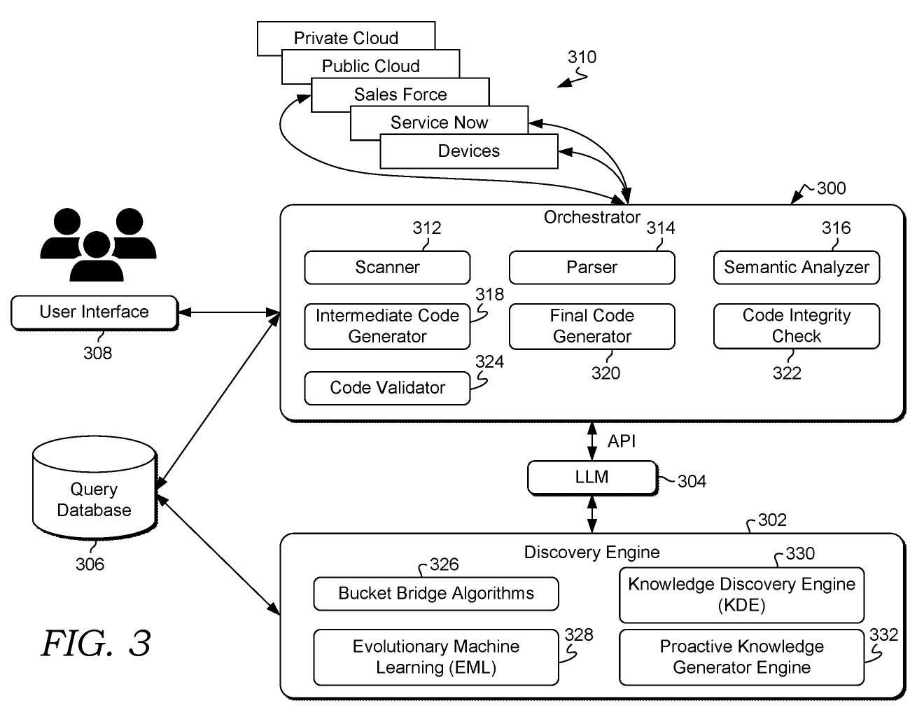

FIG. 3 illustrates an example orchestrator 300 that may be used to generate the computer-executable action. Components of orchestrator 300 may further utilize discovery engine 302. In the example provided by FIG. 3, components of orchestrator 300 interface with LLM 304, which may include any LLM previously described, such as LLM 214. In general, FIG. 3 is provided to illustrate one example. Other arrangements and functionality may be employed.

In another aspect, LLM 304 is trained on system specific scripts. For instance, LLM 304 may be trained using scripts configured to operate in a specific operating system such as powershell, bash, or other script configured to a particular operating system. System specific scrips on which LLM 304 is trained may include specific library, such pre-written code or functions for a particular system type; specific data files, such as files that include data structured for use by a particular system; a specific address, such as a unique location or identified within a network or memory used by scripts or applications to locate resources. Base on its training, LLM 304 may output scripts configured to operate on a specific device, e.g., one employing a particular type of operating system, a specific application, or the like. In an aspect, components of discovery engine 302 maybe be used to train LLM 304.

As illustrated, orchestrator 300, and other components, may communicate with query database 306. In general, query database 306 may store queries, including an initial input, prompt, or modified prompt that may be provided to or generated by components of orchestrator 300 or LLM 304. The stored data may be used for the training of a machine learning model or referenced by various machine learning models for contextual understanding.

The example of FIG. 3 also illustrates orchestrator 300 interfacing with user interface 308. In general, users may use a computing device corresponding to user interface 308 to provide input data, such as an input for prompt generation. The input may include a request to perform a computer-executable action. User interface 308 may receive an input in any form, including voice, text, image, or another input. Aspects may include an API interface for machine-to-machine communication (e.g., XML, JSON messages, or RESTful API calls).

FIG. 3 also includes example end computing systems 310. These examples are not intended to be limiting, and other end computing systems may be used by the technology. In general, an end computing system may be a computing system that is configured to perform a computer-executable action. The end computing system may execute the computer-executable action upon receipt of an executable script that includes data or instructions corresponding to the action. The executable script may be in an XML form, a JSON or JWT (JSON Web Token), an API call, or another like form that can be understood by the end computing system and used when executing the action. An end computing system may be one or more computing device executing any combination of function. In an aspect, the end computing system is different from a computing device hosting orchestrator 300. In another aspect, the end computing system is the same device that hosts orchestrator 300.

In aspects, orchestrator 300 receives input from user interface 308. The input may request a computer-executable action. Based on the action, orchestrator 300 may determine whether there is an end computing system configured to perform the computer-executable action. Orchestrator 300 may interface with LLM 304 to generate an executable script that can be provided to the identified end computing system, which causes the end computing system to perform the action requested by the input, thereby allowing a natural language input to be converted to a computer script. Orchestrator 300 illustrates various functional components that may be employed. These are examples. Other arrangements may have more or fewer components.

When a natural language input is received, orchestrator 300 can pass the natural language input to LLM 304. This leverages the ability to LLM 304 to contextualize natural language. In aspects, orchestrator 300 provides the input as a prompt to LLM 304. In doing so, orchestrator 300 may modify the prompt. The prompt may be modified to include a command to generate a computer executable script that includes computer instructions for performing the requested action. In aspects, orchestrator 300 identifies computer language requirements of the end computer system and modifies the prompt to request the identified computer language when generating the script. In response, LLM 304 generates an initial script that includes computer instructions for the requested action. The initial response is received by orchestrator 300.

Orchestrator 300 can receive the initial script from LLM 304, i.e., a first machine learning model, and modify it to generate an executable script. The modification can include using a second machine learning model, as will be described. In the example illustrated, orchestrator 300 includes scanner 312, parser 314, semantic analyzer 316, intermediate code generator 318, final code generator 320, code integrity check 322, and code validator 324. One or more of the components may be used when generating executable scripts.

In aspects where LLM 304 is trained on system specific scripts, orchestrator may employ one or more models, such as LLM 304 to generate an executable script. For instance, orchestrator 300 may provide a prompt input to LLM identifying a specific end system (e.g., a specific device or specific application) and natural language requesting a specific executable script.

Scanner 312 generally scans the response from the LLM 304. It may listen for LLM 304 responses in a multi-user environment and allocate the response to the proper conversation. For instance, it may match input from a user with prior inputs, prompts, or responses stored in query database 306 for the same machine or user.

Parser 314 generally extracts information from the initial script of LLM 304. In aspects, the initial script may include portions having natural language. These may be parts of the script where execution-specific data is used, such as language that identifies that a specific library, specific data file, specific address, or the like is needed. Parser 314 may use named-entity recognition (NER) to extract the information within the initial script.

Semantic analyzer 316 may employ the use of a second machine learning model to modify the initial script. In general, semantic analyzer 316 verifies a syntax of the input initial script. For instance, semantic analyzer 316 verifies the syntactical accuracy of the initial script output from 304 after scanner 32 scans the output of LLM 304 and the output of LLM 304 has been parsed to extract information from the initial script. In aspects, semantic analyzer 316 employs a model provided by discovery engine 302, as will be described. Semantic analyzer 316 generally identifies a portion of the initial script and modifies it by deletion or replacement using one or more machine learning models, such as LLM 304. The modified portion may include an end computing system specific modification. The instructions modified may include instructions specific to the end computing system or action, such as a specific library, address, or the like.

In aspects, the output of LLM 304 may be further modified. For instance, semantic analyzer 316 identifies the portion of an initial script for modification, and the modification is performed using intermediate code generator 318 to generate the executable script. For instance, semantic analyzer 316, using discovery engine 302, may identify generic elements in the initial script of the first machine learning model and modify the generic elements with end computing system specific elements for execution by the end computing system.

In aspects, a final code generator 320 may be employed to format the executable script to a particular data serialization format. As noted, some end computing systems use specific data serialization format, such as XML, JSON, API calls, and so forth. Final code generator 320 may generate a final executable script having the data serialization format corresponding to the end computing system.

Code integrity check 322 may be employed to check the integrity of the executable script. For instance, this may include an automatic acceptance test or a dry run in a suitable sandbox. Code integrity check 322 may verify the final syntax for the end computing system. For example, if the final output is XML, XSD is used to check the accuracy.

Code validator 324 may be used to verify a workflow that includes the executable script. For instance, it may use a man-in-the-loop simulation for validation. Code validator 324 may validate compliance with security policies or other policies. In aspects, it determines whether the user (human or machine) has the authority and the clearance to execute the process, e.g., the required credentials.

As previously noted, semantic analyzer 316 may use discovery engine 302 when employing the second machine learning model to modify the initial script and generate the executable script. In the example illustrated, discovery engine 302 includes bucket brigade algorithm 326, evolutionary machine learning 328, knowledge discovery engine 330, and proactive knowledge generator engine 332. As with orchestrator 300, each of these components is intended to provide an example. More or fewer components may be suitable.

In aspects, evolutionary machine learning 328 and knowledge discovery engine 330 provide a multiple-classifier system. The classifiers of the multiple-classifier system can utilize bucket brigade algorithm 326. Knowledge discovery engine 330 provides additional rules beyond those of LLM 304 by modifying the output of LLM 304. The rules of the orchestrator 300 can be in the form of a production system: e.g., If <condition> then <action>:<message>.

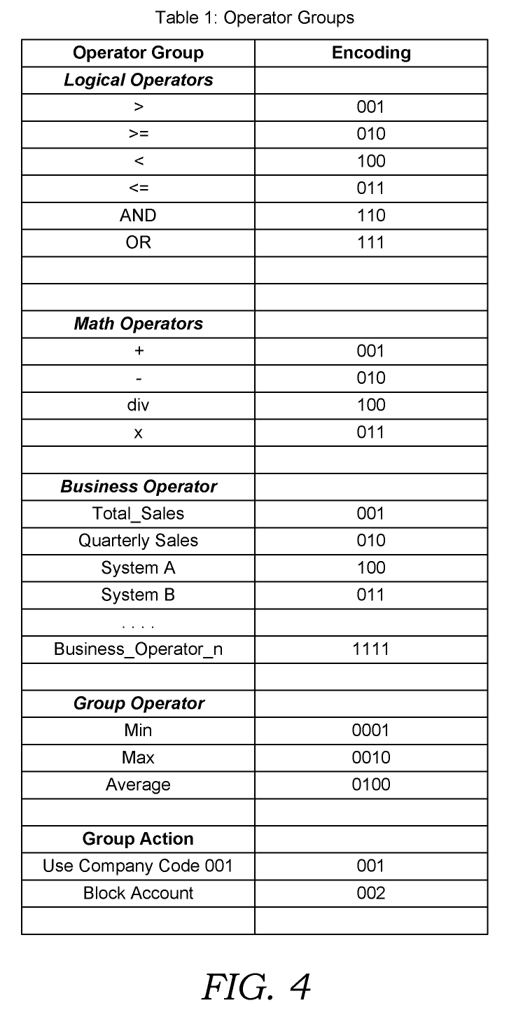

The evolutionary machine learning 328 is based on a semantic alphabet of symbols and is coded in binary strings. The semantic alphabet includes different operator groups, and each of the operating groups can be represented using a binary code. An example is provided in Table 1 of FIG. 4, which generally illustrates example operator encodings that may be used when training a machine learning model to generate executable scripts. This is just an example, and other encoding schemes may be used. In an example, the number of bits used to codify each operator equals n, such that pov(2,n) = #operators. The evolutionary machine learning 328 generates random rules using the encoded representations of the operators. For instance, a random sequence of binary digits can be generated to represent a random rule, e.g., in the format of 00010010100101010101010000101. N number of rules are generated. As an example, 100 random rules can be generated. As an example, "IF (Business Operator_X) (Logical_Operator_X) THEN Action_Z" could be represented in binary form.

The bucket brigade algorithm 326 may operate as follows: Each rule has an initial value of points, e.g., 1,000 points. During the training (knowledge discovery), each rule bids an amount equal to a percentage of its value, such as 5%. If the rule is correct (knowledge testing), it gains the amount bid by the wrong rules. Rules that have a value below a threshold are removed and replaced by rules created as a crossover of randomly selected rules among the top rules, such as randomly selecting two of the top ten rules. For instance, rules having 0 value can be removed.

Proactive knowledge generator engine 332 uses reinforcement learning to query database 306, generate new (unseen) queries for the LLM 304, and test the production system rules. Working with the orchestrator 300, the proactive knowledge generator engine 332 refines the rules and anticipates future user requests.

In an aspect, a second machine learning model of discovery engine 302 can be trained by generating a prompt for a script. The prompt requests a computer-executable action. A plurality of prompts is generated. The plurality may be generated to have a same semantic meaning as the initial prompt. For instance, an initial prompt may be generated and the initial prompt may be provided to a generative AI, such as LLM 304 with a request to generate semantically similar prompts as outputs. The prompts generated can be associated with known computer instructions for the computer-executable action. The machine learning model is trained to generate a script that, when executed, causes an end computing system to execute the computer-executable action. The training can be done using evolutionary machine learning, for instance, by generating random binary codes as previously described. In an aspect, a genetic algorithm is employed to train the machine learning model using the rules, translated from the generated rules, as an initial population.

As noted previously, an executable script may be generated and provided to an end computing system. Upon receiving the executable script, the end computing system may execute the script. Where the script was executed without error, an indication of such may be received. The prompt provided to the first machine learning model, the output initial script, the executable script, and the indication that there was no error in the execution, or any combination thereof, can be stored for training the second machine learning model.

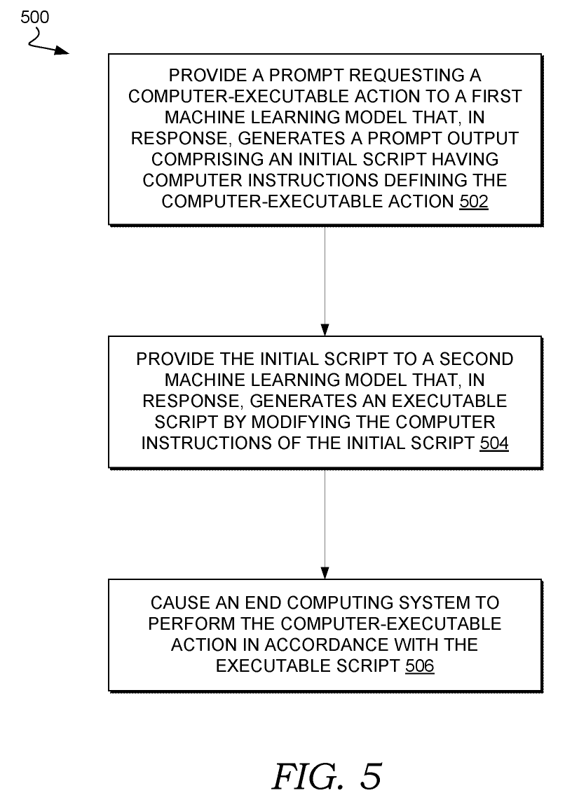

With reference now to FIG. 5, a block diagram having an example method 500 for generating an executable script and causing an end computing system to execute the script is provided. Each block of method 500 may comprise a computing process performed using any combination of hardware, firmware, or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few possibilities.

In block 502, method 500 provides a prompt requesting a computer-executable action to a first machine learning model that, in response, generates a prompt output comprising an initial script having computer instructions defining the computer-executable action. The first machine learning model may be an LLM, such as those previously described. The LLM may be trained on a diverse dataset comprising a plurality of unrelated data domains. The first machine learning model may employ natural language processing to receive a prompt in a natural language form and from it generate the initial script. In an aspect, the first machine learning model is a generative pre-trained transformer.

In an aspect, input is received from a user, e.g., a user computing device. The input may include a request for a computer-executable action. The prompt can be generated from the input and include the request for the computer-executable action. In some cases, the generated prompt includes additional data on which the first machine learning model was not trained. The prompt may be generated to indicate a specific computer language, based on the end computing system, for the output initial script. This may be done using orchestrator 300, as previously described.

In block 504, method 500 provides the initial script to a second machine learning model that, in response, generates an executable script by modifying the computer instructions of the initial script. This may be done using orchestrator 300 in coordination with discovery engine 302. In aspects, the second machine learning model is trained using system specific scripts, as previously described. For instance, the second machine learning model may be trained using evolutionally learning and a bucket brigade algorithm. In some cases, the second machine learning model identifies generic elements within the initial script generated by the first machine learning model and modifies the generic elements with end computing system specific elements. For instance, it may modify the initial script to include specific libraries, addresses, or other like elements.

In an aspect, the end computing system uses a specific data serialization format. The end computing system may be identified along with any specific data serialization format that it uses, such as a specific API call. The executable script may be formatted to comply with the data serialization format.

In block 506, method 500 causes an end computing system to perform the computer-executable action in accordance with the executable script. In aspects, the executable script and causing the end computing system to perform the computer-executable action may be done automatically in response to receiving the input.

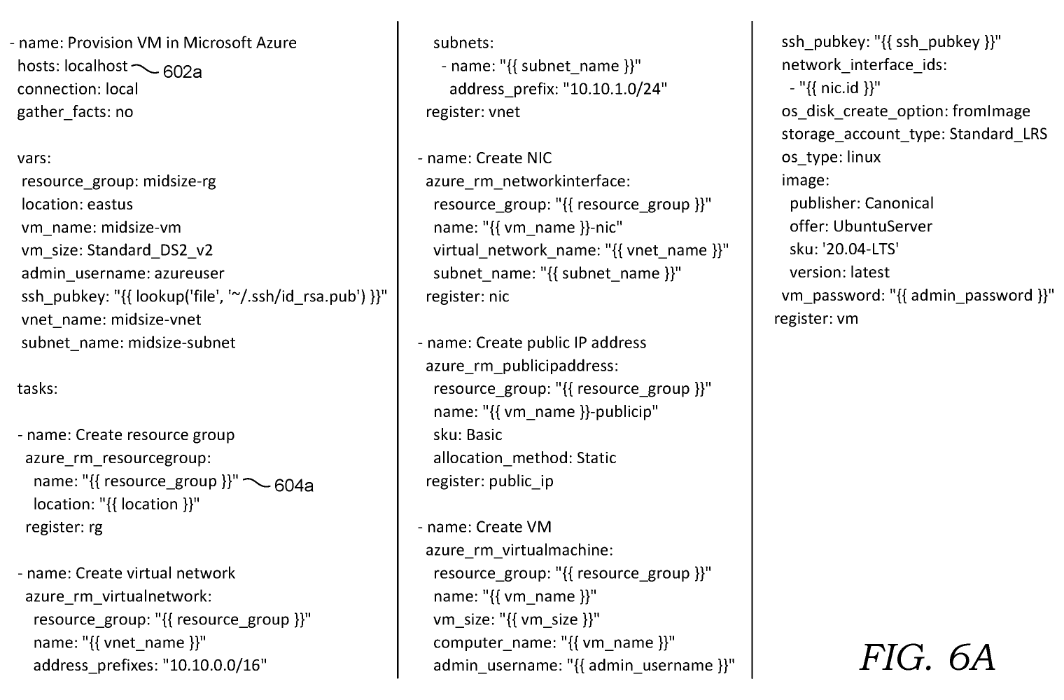

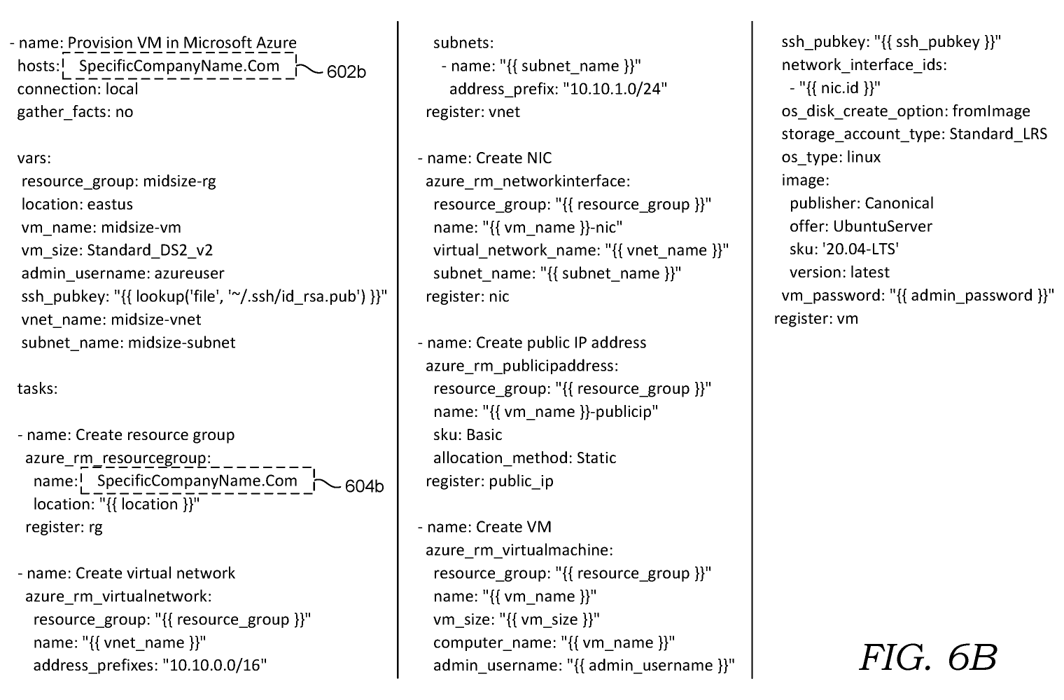

FIG. 6A and FIG. 6B illustrate an example initial script and executable script, respectively, generate according to the foregoing description. FIG. 6A illustrates an example initial script generated by a first machine learning model in response to a prompt. The prompt was generated to include an input comprising: “Generate an ansible script to create a midsize system in Microsoft Azure." FIG. 6A is provided to a second machine learning model, such as those described and executed by orchestrator 300. The second machine learning model identifies generic element 602a and generic element 604a as generic elements within the initial script of FIG. 6A, and replaces them with system specific element 602b and system specific element 604b, respectively. In this case, these are specific addresses for the local host and the resource group that are used by an end computing system to execute the script. As noted, the executable script of FIG. 6B may be further formatted to comply with a data serialization format of the end computing system at which it is executed, such as a specific API call used by the end computing system. This is just one example, and only a select number of elements have been identified and replaced for clarity.

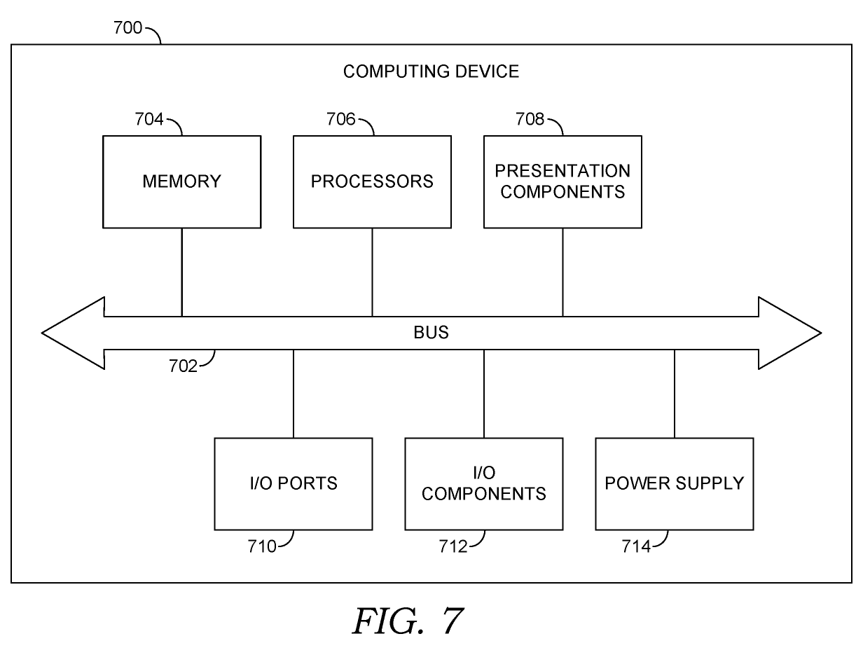

The foregoing function may be executed by a computing device. An example computing environment in which embodiments of the present technology may be implemented is described below in order to provide a general context for various aspects of the present technology. Referring now to FIG. 7 in particular, an example operating environment for implementing embodiments of the present technology is shown and designated generally as computing device 700. Computing device 700 is but one example of a suitable computing environment and is not intended to suggest any limitation as to the scope of use or functionality of the technology. Computing device 700 should not be interpreted as having any dependency or requirement relating to any one or combination of components illustrated.

The present technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 7, computing device 700 includes bus 702, which directly or indirectly couples the following devices: memory 704, one or more processors 706, one or more presentation components 708, input/output (I/O) ports 710, input/output components 712, and illustrative power supply 714. Bus 702 represents what may be one or more buses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 7 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 7 and with reference to “computing device.”

Computing device 700 typically includes a variety of computer-readable media. Computer-readable media can be any available media that can be accessed by computing device 700 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 700. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 704 includes computer storage media in the form of volatile or non-volatile memory. The memory may be removable, non-removable, or a combination thereof. Example hardware devices include solid-state memory, hard drives, optical-disc drives, etc. Computing device 700 includes one or more processors that read data from various entities, such as memory 704 or I/O components 712. Presentation component(s) 708 presents data indications to a user or other device. Example presentation components include a display device, speaker, printing component, vibrating component, etc.

I/O ports 710 allow computing device 700 to be logically coupled to other devices, including I/O components 712, some of which may be built-in. Illustrative components include a microphone, joystick, game pad, satellite dish, scanner, printer, wireless device, etc. The I/O components 712 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 700. Computing device 700 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 700 may be equipped with accelerometers or gyroscopes that enable detection of motion. The output of the accelerometers or gyroscopes may be provided to the display of computing device 700 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. Any other variations and combinations thereof are contemplated within embodiments of the present technology.

With reference to the figures generally, databases generally store information, including data, computer instructions (e.g., software program instructions, routines, or services), or models used in embodiments of the described technologies. Although depicted as a single database component, database 106 may be embodied as one or more databases or may be in the cloud.

Components may communicate through one or more networks (e.g., public network or virtual private network [VPN]). Networks may include, without limitation, one or more local area networks (LANs), wide area networks (WANs), or any other communication network or method.

Having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Further, some of the elements described are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the words “including," “having," and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As further used herein, the term “train," when referring to training a machine learning model, may mean training an untrained model, further training a previously trained model, fine-tuning a pre-trained model, or the like. “Train” is intended to broadly cover methods of machine learning using a dataset.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

What is claimed is:

1. One or more computer storage media storing instructions thereon that, when executed by a processor, cause the processor to perform operations for script execution, the operations comprising:
receiving a prompt output from a first machine learning model, the prompt output generated by the first machine learning model in response to a prompt requesting a computer-executable action;
generating an executable script using a second machine learning model, the second machine learning model receiving the prompt output generated by the first machine learning model; and
causing an end computing system to perform the computer-executable action in accordance with the executable script.

2. The media of claim 1, wherein:
the first machine learning model is trained on a diverse dataset comprising a plurality of unrelated data domains; and
the second machine learning model is trained to generate system specific scripts.

3. The media of claim 1, wherein:
the prompt output comprises an initial script to perform the computer-executable action; and
the second machine learning model modifies the initial script from the first machine learning model to generate the executable script, such that the executable script is executable by the end computing system based on the end computing system being identified in the prompt requesting the computer-executable action.

4. The media of claim 1, further comprising:
determining that the end computing system performed the computer-executable action in response to the executable script without error; and
based on the end computing system performing the computer-executable action without error, storing the prompt provided to the first machine learning model and the executable script as training data for the second machine learning model.

5. The media of claim 1, further comprising:
receiving an input requesting the computer-executable action, the input being in a natural language form; and
generating the prompt from the input that includes the computer-executable action, wherein the end computing system is caused to perform the computer-executable action as an automatic response to receiving the input.

6. The media of claim 1, further comprising modifying the executable script from the second machine learning model to conform to a particular data serialization format for causing the end computing system to perform the computer-executable action.

7. The media of claim 1, wherein the second machine learning model is optimized using a bucket brigade algorithm.

8. A system for script execution, the system comprising:
at least one processor; and
one or more computer storage media storing instructions thereon that when executed by the at least one processor, cause the at least one processor to perform operations comprising:
providing a prompt requesting a computer-executable action to a first machine learning model that, in response, generates a prompt output comprising an initial script having computer instructions defining the computer-executable action;
providing the initial script to a second machine learning model that, in response, generates an executable script by modifying the computer instructions of the initial script; and
causing an end computing system to perform the computer-executable action in accordance with the executable script.

9. The system of claim 8, wherein:
the first machine learning model is trained on a diverse dataset comprising a plurality of unrelated data domains; and
the second machine learning model is trained to generate system specific scripts.

10. The system of claim 8, wherein modification to the initial script is based on the end computing system being identified in the prompt to the first machine learning model.

11. The system of claim 8, further comprising:
determining that the end computing system performed the computer-executable action in response to the executable script without error; and
based on the end computing system performing the computer-executable action without error, storing the prompt provided to the first machine learning model and the executable script as training data for the second machine learning model.

12. The system of claim 8, further comprising:
receiving an input requesting the computer-executable action, the input being in a natural language form; and
generating the prompt from the input that includes the computer-executable action, wherein the end computing system is caused to perform the computer-executable action as an automatic response to receiving the input.

13. The system of claim 8, further comprising modifying the executable script from the second machine learning model to conform to a particular data serialization format for causing the end computing system to perform the computer-executable action.

14. The system of claim 8, wherein the second machine learning model is optimized using a bucket brigade algorithm.

15. A computer-implemented method of script execution, the method comprising:
employing a first machine learning model configured to generate an initial script as a prompt output, the initial script having computer instructions defining a computer-executable action requested by a prompt input to the first machine learning model;
employing a second machine learning model configured to generate an executable script by modifying the computer instructions of the initial script from the first machine learning model; and
causing an end computing system to perform the computer-executable action in accordance with the executable script.

16. The computer-implemented method of claim 15, wherein:
the first machine learning model is configured to generate the initial script based on the first machine learning model being trained on a diverse dataset comprising a plurality of unrelated data domains; and
the second machine learning model is configured to generate the executable script based on the second machine learning model being trained on system specific scripts.

17. The computer-implemented method of claim 15, wherein modification to the initial script is based on the end computing system being identified in the prompt to the first machine learning model.

18. The computer-implemented method of claim 15, further comprising:
determining that the end computing system performed the computer-executable action in response to the executable script without error; and
based on the end computing system performing the computer-executable action without error, storing the prompt provided to the first machine learning model and the executable script as training data for the second machine learning model.

19. The computer-implemented method of claim 15, further comprising:
receiving an input requesting the computer-executable action, the input being in a natural language form; and
generating the prompt from the input that includes the computer-executable action, wherein the end computing system is caused to perform the computer-executable action as an automatic response to receiving the input.

20. The computer-implemented method of claim 15, further comprising modifying the executable script from the second machine learning model to conform to a particular data serialization format for causing the end computing system to perform the computer-executable action.
